(19) United States
(12) Patent Application Publication
(10) Pub. No.: US 2026/0319831 A1
(43) Pub. Date: Oct. 15, 2026

(54) APPARATUS AND METHOD OF APPLICATION EXECUTION

(71) Applicant: Sony Interactive Entertainment Inc., Tokyo (JP)

(72) Inventors: Maurizio Cerrato, London (GB); Lawrence Green, London (GB); Jun Yen Leung, London (GB); Maria Chiara Monti, London (GB); Patrick Connor, London (GB); Rajeev Gupta, London (GB)

(73) Assignee: Sony Interactive Entertainment Inc., Tokyo (JP)

(21) Appl. No.: 19/467,143

(22) Filed: Feb. 2, 2026

(30) Foreign Application Priority Data
Feb. 5, 2025 (GB) 2501646.0

(51) Int. Cl. G06F 9/48; A63F 13/355; G06F 8/61; G06F 11/1446

(52) U.S. Cl. CPC G06F 9/4856; A63F 13/355; G06F 8/61; G06F 11/1446

(57) ABSTRACT

A method can include, for executable content that a user has access to, providing a streaming instance of the executable content to a client device for immediate use, downloading a local instance of the executable content to the client device, and installing the local instance of the executable content on the client device. When the local instance of the executable content is installed and ready to run on the client device, the method includes selecting a swap-over point between the streaming instance and the local instance, creating a save file at the swap-over point, and downloading the save file to the client device. The method can also include running the local instance of the executable content in a mode that starts the executable content using the save file and transferring the user from the streaming instance to the local instance of to continue their use of the executable content.

### CROSS-REFERENCES TO RELATED APPLICATIONS

This application claims the benefit of and priority to United Kingdom (GB) Application No. 2501646.0, filed on Feb. 5, 2025, the entire disclosure of which is hereby incorporated by reference in its entirety for all purposes.

### TECHNICAL FIELD

The present disclosure relates to an application and method of application execution.

### BACKGROUND OF INVENTION

Modern videogames can be very large; for example in the order of 50 to 100 gigabytes. For some users, this can mean it takes several hours to download a game to their videogame console or PC, and that this download can also affect the responsiveness of other online services at home. In the meantime, the user is unable to play the game.

Some of these issues can be mitigated by the ability to download a game when the console is in a sleep mode, and optionally also by scheduling downloads to a future release date; however, these are not available for the case of a user simply obtaining a game online for notionally immediate use, and similarly may not be available when buying additional downloadable content for a game, or downloading a patch for a game (which can often occur immediately after downloading the original version of the game, exacerbating the original problem). This issue more generally applies to any large executable content that needs to be downloaded.

Embodiments of the present disclosure seek to address or mitigate this problem.

### SUMMARY

Various aspects and features of the present disclosure are defined in the appended claims and within the text of the accompanying description.

In a first aspect, a method of application execution is provided. The method can include, for executable content that a user has access to, providing a streaming instance of the executable content to a client device of the user for immediate use; downloading a local instance of the executable content to the client device of the user; and installing the local instance of the executable content on the client device of the user; and when the local instance of the executable content is installed and ready to run on the client device: selecting a swap-over point between the streaming instance and the local instance of the executable content; at the swap-over point, creating a save file that enables resumption of the executable content from the swap-over point; downloading the save file to the client device of the user; running the local instance of the executable content in a mode that starts the executable content using the save file to start the executable content at the swap-over point; and transferring the user from the streaming instance of the executable content to the local instance of the executable content to continue their use of the executable content.

In another aspect, a-transitory computer-readable medium embodying computer executable instructions is provided. The instructions, when executed by a computer system, cause the computer system to: for executable content that a user has access to: provide a streaming instance of the executable content to a client device of the user for immediate use; download a local instance of the executable content to the client device of the user; and install the local instance of the executable content on the client device of the user; and when the local instance of the executable content is installed and ready to run on the client device: select a swap-over point between the streaming instance and the local instance of the executable content; at the swap-over point, create a save file that enables resumption of the executable content from the swap-over point; download the save file to the client device of the user; run the local instance of the executable content in a mode that starts the executable content using the save file to start the executable content at the swap-over point; and transfer the user from the streaming instance of the executable content to the local instance of the executable content to continue their use of the executable content.

In another aspect, a client device is provided. The client device can include one or more processors; and a memory storing instructions that, when executed by client device using the one or more processors, cause the client device to: for executable content that a user has access to: provide a streaming instance of the executable content to a client device of the user for immediate use; download a local instance of the executable content to the client device of the user; and install the local instance of the executable content on the client device of the user; and when the local instance of the executable content is installed and ready to run on the client device: select a swap-over point between the streaming instance and the local instance of the executable content; at the swap-over point, create a save file that enables resumption of the executable content from the swap-over point; download the save file to the client device of the user; run the local instance of the executable content in a mode that starts the executable content using the save file to start the executable content at the swap-over point; and transfer the user from the streaming instance of the executable content to the local instance of the executable content to continue their use of the executable content.

In another aspect, a server system is provided. The server system can include one or more processors; and a memory storing instructions that, when executed by the one or more processors, cause the server system to: receive a request to provide a streaming instance of an executable content that a user has access to, for the user to immediately use; run the streaming instance of the executable content for the user; provide the streaming instance of the executable content to the user; download a local instance of the executable content to the client device of the user; select a swap-over point between the streaming instance and the local instance of the executable content once the local instance of the executable content is installed on the client device of the user; create a save file that enables resumption of the executable content from the swap-over point; download the save file to the client device of the user; and transfer the user from the streaming instance of the executable content to the local instance of the executable content to continue their use of the executable content. In one example of the present disclosure, a system is provided. The system can include one or more server systems and one or more client devices. In such examples, the one or more server systems can comprise one or more servers having allocated between them the roles of streaming the executable content and downloading the executable content.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description.

FIG. 2 is a schematic diagram of a system in accordance with embodiments of the present description.

FIG. 3 is a flow diagram of a method of application execution in accordance with embodiments of the present description.

### DESCRIPTION OF THE EMBODIMENTS

An application and method of application execution are disclosed. In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

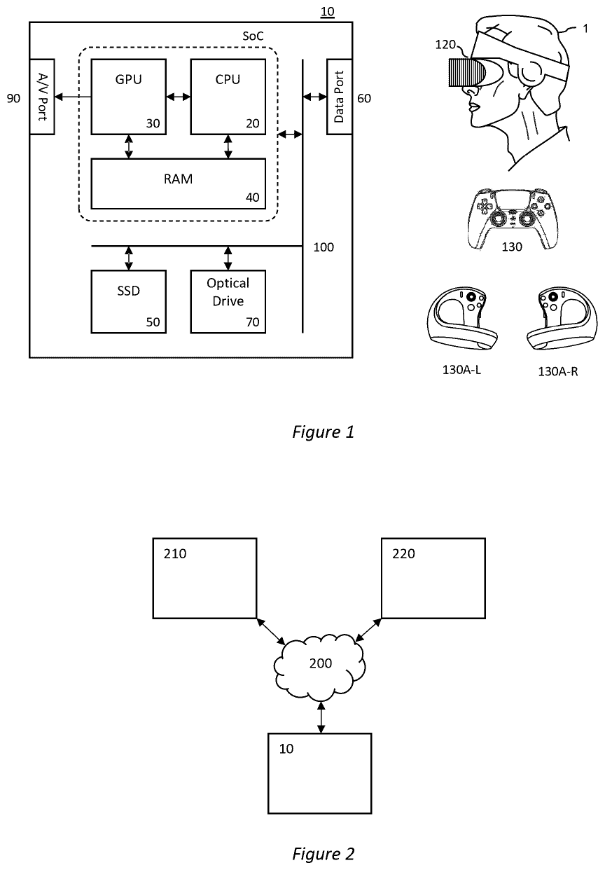

Referring now to the drawings, wherein like reference numerals designate identical or corresponding parts throughout the several views, FIG. 1 shows a computer or videogame console that can be referred to more generally as an entertainment system or device 10.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display ‘HMD’ 120, worn by a user 1.

Interaction with the system is typically provided using one or more handheld controllers 130, and/or one or more VR controllers (130A-L,R) in the case of the HMD.

Referring now to FIG. 2, such an entertainment system 10 may communicate with one or more servers 210, 220, via a network 200 such as the internet. The servers may have a typical server hardware architecture, and/or for the purposes of explanation, have a hardware architecture similar to entertainment system 10.

In embodiments of the present description, there is provided a streaming server 210 and a download server 220. Optionally a single server may provide both functions, and so more generally there are one or more servers providing a combination of streaming and download services to the entertainment device 10 in any suitable combination.

In embodiments of the present description, a user opts to acquire a game (or any other application that is normally downloaded and run locally, hereafter incorporated into the umbrella term of ‘game’). Assuming the acquisition is successful (for example the user pays for the game, or the game is available to them as part of e.g. a subscription package) then normally the game starts to be downloaded, and the user must wait for the download to be completed. As noted elsewhere herein, this can be very inconvenient.

Accordingly, in embodiments of the present description, when the user successfully acquires a game, then if they indicate a wish to immediately play the game (or more generally to play the game before download is complete), then a game streaming client is launched on their entertainment device, and a corresponding game instance is launched (or, more generally, made available) for the client at the streaming server 210. The server may associate the game instance with the client (or vice-versa) by reference to a user account ID. In addition, a game download status is initialized on the client and/or the download server 220.

The streaming server then proceeds to stream the game to the game streaming client on the user's entertainment device in a conventional manner, thereby enabling the user the immediately play the game they have purchased.

Meanwhile, separately the game also starts to download to the entertainment device from the download server. Hence packets of streaming data and download data are typically received in parallel.

In embodiments of the present description, one or more of the entertainment device, the streaming server, and the download server co-operate to set the priority of streaming packets to be higher than those of download packets, in order to preserve at least a minimum quality of service ‘QoS’ for the streaming of the game. This may be achieved by default, with the streaming server always having a first priority and the download server always having a second, lower priority. Alternatively or in addition, the streaming client of the entertainment device may set or vary the relative priority of the packets, for example in response to a QoS metric associated with the streaming service.

Hence for example the priority of download packets could be incrementally increased as long as the streaming QoS metric or metrics were met (for example mean delay to display of generated scene at a target resolution, frame-rate, and/or quality, and/or mean delay of upload of user inputs, and the like).

This may reflect that a user's internet connection is likely not being used solely for the entertainment device, and so packet priorities may be evaluated by a routing scheme with respect to the needs of other devices of the user as well; having a low priority may unnecessarily slow the download of the game because other non-critical packets unrelated either to streaming or the download have a higher priority in the user's network. Therefore dynamic adjustment of the priority of the download packets (and optionally also the streaming packets) can take account of other traffic for the user's local network, and optionally their QoS requirements as well, if specified.

In any event, in general the streaming packets will at least initially have a higher priority than the download packets, with the priority of download packets optionally increasing and possibly exceeding those of streaming packets as long as a predefined minimum streaming quality of service is maintained. Meanwhile one or both priorities may increase as necessary depending on the amount of other traffic for the user's local network.

When streaming the game, the user may save and load game-saves (records of in-game progress or state) on the game streaming service in a transparent manner (e.g. as if playing locally), and their saves are associated with their account ID. Hence the user can stop playing the game if they wish, and subsequently resume, on the streaming service.

Hence in embodiments of the present description, the acquired game may display within the client device's user interface as available to play, like other installed games, and the user can access it in a similar manner, but while the game is not yet locally available to play (e.g. the game download status is set to indicate this), accessing the game will instead cause it to be provided by the streaming service, in association with the user's ID.

This continues until in due course the game is downloaded onto the user's entertainment device and installed, typically as a background activity, and the game download status is set to indicate the availability of the game for local execution.

Typically this means the game is fully downloaded and installed. However optionally it can mean that the game is downloaded and installed merely to a sufficient extent that the user can play it (as described in more detail elsewhere herein).

In any event, once the game is available to the user locally on their entertainment device, it becomes possible to move from the streaming instance of the game to a local instance of the game. It is preferable to do this as seamlessly as possible.

This readiness can be signaled to the streaming server and/or download server, for example by uploading a suitable notification. Alternatively it could be signaled by the download server completing the download process, and assuming installation of the game is prompt or has occurred as download progressed.

Once available, if the user is currently streaming the same game, the local instance of the game can start loading (i.e. getting ready for play) as a background activity.

Meanwhile the streaming process is a lightweight, non-gaming application and can run on limited resources of the entertainment device in parallel as the game is loading.

The game is configured in this mode (i.e. a segue from streaming to local play) to be able to start directly from a game-save without running through any welcome screens, initial menus, character set-ups, or cut-scenes that it may normally start with, on the assumption that these have been done when streaming.

Once the local instance of the game is ready to switch from a background activity to being the focal application that the user then plays on (in other words it is ready to take over from the streamlined instance), the process of moving the user from the streaming instance to the local instance can start.

The developer of the game can set swapping points within the game, for example every few minutes or every 5-10 minutes, or swapping points can coincide with sections of the game that are normally accompanied by the loading of new game assets-for example so-called ‘fast travel’ between regions of a game world, or where the game loads new environments in the background (historically for example in a transit corridor or narrow path in-game to allow for the loading time, but not necessarily). Similarly swapping points can coincide with sections of the game where user input is not necessary, such as cut scenes, or when a ‘level up’ or similar event such as an in-game message interrupts normal play. Hence more generally such swapping points can be periodic, location dependent, and/or event dependent. Whilst the developer may explicitly set these points, optionally the streaming server or the streaming client can automatically identify candidate points. These may occur for example when the user selects an in-game UI (e.g. a load/save UI, a settings UI, an inventory UI or a fast travel UI) and could be detected because the normal game environment is no longer being rendered. Similarly, the loading of a set of new assets (due to starting a new area or the like) can be detected automatically, as can auto-save events or the like instigated by the game itself.

In any event, when a swapping point is encountered after the local game is ready to play, a save game is automatically created at the streaming server and promptly downloaded to the entertainment device, where it is provided to the local game to define how it starts. For example, it could be provided to the local instance of the game as the game save normally used by the game to implement a ‘continue’ option.

Since the swapping point typically either involves no input from the user, and/or an expected pause as the game changes state, any small additional pause created by saving, downloading, and using the game state of the streaming instance of the game with the local instance of the game will have a limited impact on the user.

Typically, once the save-game is created at the server, the game on the server pauses output (i.e. continues to output the same state), so that when the local instance of the game starts with the save game, the state is identical and the local instance can take over without any visual discontinuity.

As it is preferable to swap from the server to the local client quickly, optionally the game save may be compressed for transmission, if the overall time taken to compress, transmit, and decompress the game save would be faster than just transmitting it. It will also be appreciated that using a solid state drive on the local device, and any acceleration techniques relating to local storage, will also be of benefit for this process.

In any event, once the game save has been successfully used to start the local instance of the game play, this can be notified from the client device to the streaming server, which can then close, reset, go idle, and/or reassign the streaming instance of the game to another user. Meanwhile as the game download status has been set to indicate the availability of the game for local execution, the game will now run locally each time the user chooses to play it.

Optionally, the system will only indicate a permanent shift to the local instance of the game once the local instance itself has created its own local auto-save (or the user has manually saved locally), as firstly this indicates that the game is working properly and secondly means that the game state on the server side is now out of date.

By using the above techniques, beneficially a user is able to immediately start playing a game they have acquired despite it not having been sufficiently downloaded and installed to play locally, and also to seamlessly segue from the streamlined instance to the local instance once this has happened. Furthermore, because this reduces the pressure to rapidly download the game to the local device, this can improve quality of service for other devices and services on the user's network (rather than having the majority of bandwidth taken by downloading the game), and also reduces demand on the download server(s), which can be significant particularly on day one of a game launch.

Once a game has been installed locally, it may operate as normal thereafter. However, optionally, any patches or additional downloadable content (so-called ‘DLC’s) may also benefit from the techniques herein, optionally subject to a size threshold that may for example be set by the patch/content distributor, the user, and/or based on their download speed. Hence more generally the techniques herein may be applied to executable content, which may be an application, such as a game, or a DLC, or a patch for either.

In the case of a patch or DLC, however, the game is already locally playable, and typically has already been locally played and has a locally stored game-save descriptive of the current state of play by the user.

Hence in this instance, if the user acquires a new DLC or patch (or a patch or DLC is to be automatically applied) and optionally this meets a size or other criterion for using the techniques herein, then in embodiments of the present description the process may proceed as follows.

The client device changes the downloaded flag back to downloading (or alternatively or in addition uses a DLC or patching flag to similar effect), so that when the user interacts with the UI to launch the game, it goes to a server streaming instance. In this case, the instance of the game on the server streaming service already comprises the DLC or the patch that is being downloaded.

In addition, the streaming client on the entertainment device uploads the local save-game corresponding to the current local game state (e.g. the save game the local instance of the came uses for a ‘continue’ function). The uploaded save game is associated with the user's ID. The streaming game can then continue the user's play of the game, with access to the DLC and/or patched content, whilst this is being downloaded to the user's entertainment device and applied to the local instance of the game as a background activity.

Hence again the user can immediately access the updated version of the game using their current game state, even if it takes hours to update their local instance.

One the local instance of the game is updated, again the relevant flag is updated to indicate this, the updated game can be loaded up in the background as previously and the server can select a swapping point in a similar manner to that described previously, at which point it creates a save game, this is downloaded to the entertainment device, and uses to start local play with the local instance of the game in a similar manner to the described previously.

In this way, a player can enjoy ‘instant’ patching and DLC downloads.

In some cases, patches and in particular DLC are acquired from within a user interface of the game interface rather than from for example, a shop front accessed via the entertainment device OS. In this case the local game is already running and in use when the DLC or patch is requested. In this case, a local save game may be generated at the same time as the request, and uploaded to the streaming server. Subsequently the local game may acknowledge the request once the streaming server is ready to take over play using this save game. In this way, the user can go into the DLC or patch interface from the local game instance, but exit from that interface to the streamed instance, in a reverse of the original segue from streaming to local instances described previously.

Once the DLC or patch has been downloaded and installed, the user can be migrated back to the local instance as described elsewhere herein.

Hence again the user can immediately access the updated version of the game, using their current game state from local play, even if it takes hours to update their local instance.

As noted elsewhere herein, some games or applications support play before all of the game has been downloaded. This is because typically a game comprises a game engine (providing graphics rendering capabilities, user interfaces and game logic), but this may comprise only a few percent of the total game size, with most of the download comprising graphics, audio, and the like for different parts of the game.

The packaging and download of a game can be structured to provide the game engine and initial parts of the game first, so that the game can start being played whilst other, later parts of the game experience are still being downloaded.

In this case, the techniques herein may further comprise the streamed game comparing progress with the downloaded game, so that when an executable version of the game has been downloaded and installed that encompasses the progress to date of the player on the streamed version, then optionally the user can segue from the streamed version to the local version at that point.

This has the benefit of reducing the burden on the streaming server, and potentially also improving the quality of experience for the user sooner, in the event that streaming the game limits image quality or input responsiveness.

It will be appreciated that references to a downloaded flag elsewhere in the description is exemplary only, and whether to use a streaming instance or a local instance of an application can be evaluated using any suitable method, for example detecting whether a local instance of the application has been registered as available by the local operating system, or receiving notification of a requirement to patch such an application.

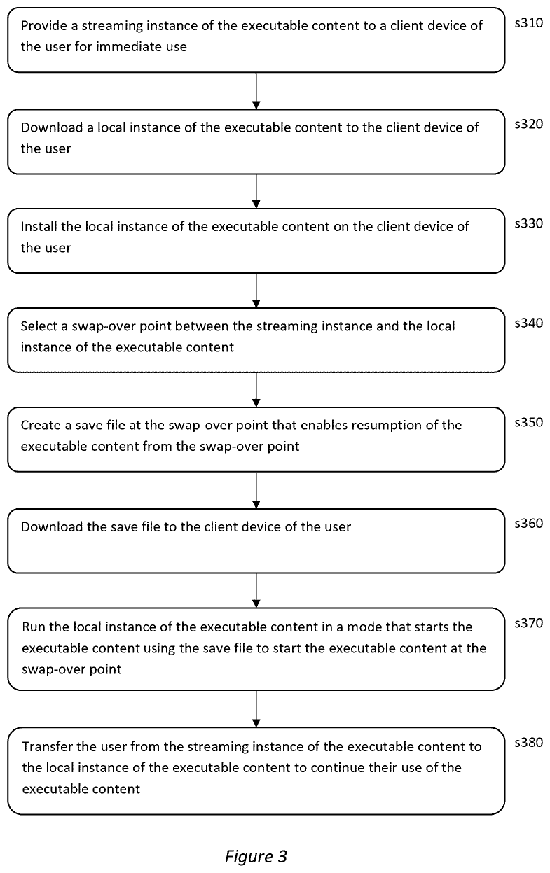

Referring now to FIG. 3, in a summary embodiment of the present description, a method of application execution comprises the following steps for executable content that a user has access to.

In a first step 310, providing (for example at a streaming server) a streaming instance of the executable content to a client device of the user (for example an entertainment device) for immediate use (where ‘immediate’ may be understood as being without the need to wait for a local instance of the executable content to download and install, or as not being conditional on running the executable content locally), as described elsewhere herein.

In a second step 320, downloading (for example at a download server or the streaming server) a local instance of the executable content to the client device of the user, as described elsewhere herein.

In a third step 330, installing the local instance of the executable content on the client device of the user, as described elsewhere herein.

When the local instance of the executable content is installed and ready to run on the client device, then in a fourth step s340, selecting a swap-over point between the streaming instance and the local instance of the executable content, as described elsewhere herein.

In a fifth step 350, creating a save file at the swap-over point that enables resumption of the executable content from the swap-over point, as described elsewhere herein.

In a sixth step 360, downloading the save file to the client device of the user, as described elsewhere herein.

In a seventh step 370, running the local instance of the executable content in a mode that starts the executable content using the save file to start the executable content at the swap-over point, as described elsewhere herein.

And in an eighth step 380, transferring the user from the streaming instance of the executable content to the local instance of the executable content to continue their use of the executable content (where transferring may be managed by one of the streaming server, the user client, or by both in coordination), as described elsewhere herein.

It will be apparent to a person skilled in the art that variations in the above method corresponding to operation of the various embodiments of the apparatus as described and claimed herein are considered within the scope of the present disclosure, including but not limited to that:
the streaming instance of the executable content is allocated a higher network priority than the download of the local instance of the executable content, as described elsewhere herein;
   in this case, optionally the network priority of at least the download of the local instance of the executable content is adjusted to increase the download speed of the local instance of the executable content, subject to the streaming instance of the executable content meeting at least a threshold quality of service metric, as described elsewhere herein;
the method comprises the steps of saving a save file for the streaming instance of the executable content, the save file being associated with an ID of the user; quitting or suspending the streaming instance of the executable content when the user quits the executable content; and loading the save file in a streaming instance of the executable content if the user accesses the executable content again before the user has been transferred to the local instance of the executable content, as described elsewhere herein;
the steps of downloading, installing, and running the local instance of the executable content comprise downloading, installing, and running a partial local instance of the executable content that contains the content required to allow transfer of the user from the streaming instance of the executable content to the local instance of the executable content at the selected swap over point, and the method comprises the step of: subsequently downloading and installing the remainder of the local instance of the executable content, as described elsewhere herein;
a selectable swap over point comprises one or more selected from the list consisting of when the executable content or the user chooses to create a save file, when the executable content would otherwise load a new section of content, when a static interface is presented by the executable content to the user, when a user task within the executable content is complete, periodically, and at predefined points in the operation of the executable content, as described elsewhere herein;
the method comprises the steps of pausing the streaming instance of the executable content at a selected swap over point until the user is transferred to the local instance of the executable content, and then closing the streaming instance of the executable content, or reallocating the streaming instance of the executable content to another user, as described elsewhere herein;
the executable content is an application (e.g. a game or other application), as described elsewhere herein;
the executable content is one or more selected from the list consisting of a patch for an existing local application; and supplementary content for an existing local application (e.g. so-called ‘DLC’), as described elsewhere herein
   in this case, optionally the method comprises the steps of selecting a swap-over point between the existing local application and a streaming instance of the application further comprising the executable content, at the swap-over point creating a save file that enables resumption of the application from the swap-over point, uploading the save file to a server configured to run the streaming instance of the application further comprising the executable content, the save file being associated with an ID of the user, running the streaming instance of the application further comprising the executable content in a mode that starts it using the save file to start at the swap-over point, and transferring the user from the local instance of the application to the streaming instance of the application further comprising the executable content, as described elsewhere herein; and
the method steps are coordinated at least in part by a helper application separate to either the local or streaming instances of the executable content, as described elsewhere herein.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realized in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring back to FIGS. 1 and 2, in a summary embodiment of the present description a client device (such as for example entertainment device 10) comprises the following.
communication means (for example data port 60 in conjunction with CPU 20) operable (for example under suitable software instruction) to request provision of a streaming instance of an executable content that a user has access to, for the user to immediately use, as described elsewhere herein;
communication means (again for example data port 60 in conjunction with CPU 20) operable (again for example under suitable software instruction) to receive the streaming instance of an executable content, as described elsewhere herein;
communication means (again for example data port 60 in conjunction with CPU 20) operable (again for example under suitable software instruction) to receive a download of a local instance of the executable content, as described elsewhere herein;
processing means (for example CPU 20) operable (again for example under suitable software instruction) to install the downloaded local instance of the executable content, as described elsewhere herein;
communication means (again for example data port 60 in conjunction with CPU 20) operable (again for example under suitable software instruction) to receive a download of a save file defining a resumable state of the streaming instance usable at a selected swap-over point, as described elsewhere herein;
processing means (again for example CPU 20) operable (again for example under suitable software instruction) to run the local instance of the executable content in a mode that starts the executable content using the save file to start the executable content at the selected swap-over point, as described elsewhere herein; and
processing means (again for example CPU 20) operable (again for example under suitable software instruction) to transfer the user from the streaming instance of the executable content to the local instance of the executable content to continue their use of the executable content, optionally in coordination with one or more servers handling one or more of the streaming and downloading functions.

Instances of this summary embodiment implementing the methods and techniques described herein for the client device (for example by use of suitable software instruction) are envisaged within the scope of the application.

Similarly, in a summary embodiment of the present description a server system may optionally comprises one or more of servers 210 and 220, which for the non-limiting purposes of explanation may have a similar architecture to entertainment device 10, the server system comprising the following.
communication means (for example data port 60 in conjunction with CPU 20) operable (for example under suitable software instruction) to receive a request to provide a streaming instance of an executable content that a user has access to, for the user to immediately use, as described elsewhere herein;
a processor (for example CPU 20) operable (again for example under suitable software instruction) to run the streaming instance of the executable content for the user, as described elsewhere herein;
communication means (again for example data port 60 in conjunction with CPU 20) operable (again for example under suitable software instruction) to provide the streaming instance of the executable content to the user, as described elsewhere herein;
communication means (again for example data port 60 in conjunction with CPU 20) operable to download a local instance of the executable content to the client device of the user, as described elsewhere herein;
a processor (again for example CPU 20) operable (again for example under suitable software instruction) to select a swap-over point between the streaming instance and the local instance of the executable content once the local instance of the executable content is installed on the client device of the user, as described elsewhere herein;
a processor (again for example CPU 20) operable (again for example under suitable software instruction) to create a save file that enables resumption of the executable content from the swap-over point, as described elsewhere herein;
communication means (again for example data port 60 in conjunction with CPU 20) operable (again for example under suitable software instruction) to download the save file to the client device of the user, as described elsewhere herein; and
a processor (again for example CPU 20) operable (again for example under suitable software instruction) to transfer the user from the streaming instance of the executable content to the local instance of the executable content to continue their use of the executable content, as described elsewhere herein.

Again, instances of this summary embodiment implementing the methods and techniques described herein for the server system (for example by use of suitable software instruction) are envisaged within the scope of the application.

Finally, referring again to FIG. 2, in a summary embodiment of the present description, a system comprises one or more client devices as summarized previously and one or more server systems as summarized previously, such server systems comprising one or more servers having allocated between them the roles of streaming the executable content and downloading the executable content.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

What is claimed is:

1. A method of application execution comprising:
for executable content that a user has access to:
providing a streaming instance of the executable content to a client device of the user for immediate use;
downloading a local instance of the executable content to the client device of the user; and
installing the local instance of the executable content on the client device of the user; and
when the local instance of the executable content is installed and ready to run on the client device:
selecting a swap-over point between the streaming instance and the local instance of the executable content;
at the swap-over point, creating a save file that enables resumption of the executable content from the swap-over point;
downloading the save file to the client device of the user;
running the local instance of the executable content in a mode that starts the executable content using the save file to start the executable content at the swap-over point; and
transferring the user from the streaming instance of the executable content to the local instance of the executable content to continue their use of the executable content.

2. The method of claim 1, wherein the streaming instance of the executable content is allocated a network priority greater than a network priority associated with downloading of the local instance of the executable content.

3. The method of claim 2, wherein the network priority associated with at least downloading of the local instance of the executable content is adjusted to increase a download speed of the local instance of the executable content, subject to the streaming instance of the executable content meeting at least a threshold quality of service metric.

4. The method of claim 1, further comprising:
saving a save file for the streaming instance of the executable content, the save file being associated with an ID of the user;
quitting or suspending the streaming instance of the executable content when the user quits the executable content; and
loading the save file in a streaming instance of the executable content if the user accesses the executable content again before the user has been transferred to the local instance of the executable content.

5. The method of claim 1, wherein downloading, installing, and running the local instance of the executable content comprises downloading, installing, and running a partial local instance of the executable content that contains content required to allow transfer of the user from the streaming instance of the executable content to the local instance of the executable content at the swap over point, and wherein the method further comprises subsequently downloading and installing a remainder of the local instance of the executable content.

6. The method of claim 1, wherein a selectable swap over point comprises one or more selected from a list comprising:
i. when the executable content or the user chooses to create a save file;
ii. when the executable content would otherwise load a new section of content;
iii. when a static interface is presented by the executable content to the user;
iv. when a user task within the executable content is complete;
v. periodically; and
vi. at predefined points in the operation of the executable content.

7. The method of claim 1, further comprising:
pausing the streaming instance of the executable content at a selected swap over point until the user is transferred to the local instance of the executable content; and
closing the streaming instance of the executable content or reallocating the streaming instance of the executable content to another user.

8. The method of claim 1, wherein the executable content is an application.

9. The method of claim 1, wherein the executable content is one or more selected from a list comprising:
i. a patch for an existing local application; and
ii. supplementary content for an existing local application.

10. The method of claim 9, further comprising:
selecting a swap-over point between the existing local application and a streaming instance of the existing local application further comprising the executable content;
at the swap-over point, creating a save file that enables resumption of the existing local application from the swap-over point;
uploading the save file to a server configured to run the streaming instance of the existing local application further comprising the executable content, the save file being associated with an ID of the user;
running the streaming instance of the existing local application further comprising the executable content in a mode that starts it using the save file to start at the swap-over point; and
transferring the user from the local instance of the existing local application to the streaming instance of the existing local application further comprising the executable content.

11. The method of claim 1, wherein the method of application execution is coordinated at least in part by a helper application separate to either the local instance of the executable content or the streaming instance of the executable content.

12. A non-transitory computer-readable medium embodying computer executable instructions that, when executed by a computer system, cause the computer system to:
for executable content that a user has access to:
provide a streaming instance of the executable content to a client device of the user for immediate use;
download a local instance of the executable content to the client device of the user; and
install the local instance of the executable content on the client device of the user; and
when the local instance of the executable content is installed and ready to run on the client device:
select a swap-over point between the streaming instance and the local instance of the executable content;
at the swap-over point, create a save file that enables resumption of the executable content from the swap-over point;
download the save file to the client device of the user;
run the local instance of the executable content in a mode that starts the executable content using the save file to start the executable content at the swap-over point; and
transfer the user from the streaming instance of the executable content to the local instance of the executable content to continue their use of the executable content.

13. The non-transitory computer-readable medium of claim 12, wherein the streaming instance of the executable content is allocated a network priority greater than a network priority associated with downloading of the local instance of the executable content.

14. The non-transitory computer-readable medium of claim 13, wherein the network priority associated with at least downloading of the local instance of the executable content is adjusted to increase a download speed of the local instance of the executable content, subject to the streaming instance of the executable content meeting at least a threshold quality of service metric.

15. The non-transitory computer-readable medium of claim 12, wherein the instructions further cause the computer system to:
save a save file for the streaming instance of the executable content, the save file being associated with an ID of the user;
quit or suspending the streaming instance of the executable content when the user quits the executable content; and
load the save file in a streaming instance of the executable content if the user accesses the executable content again before the user has been transferred to the local instance of the executable content.

16. The non-transitory computer-readable medium of claim 12, wherein downloading, installing, and running the local instance of the executable content comprises downloading, installing, and running a partial local instance of the executable content that contains content required to allow transfer of the user from the streaming instance of the executable content to the local instance of the executable content at the swap over point, and wherein the method further comprises subsequently downloading and installing a remainder of the local instance of the executable content.

17. An client device, comprising:
one or more processors; and
a memory storing instructions that, when executed by the one or more processors, cause the client device to:
for executable content that a user has access to:
provide a streaming instance of the executable content to a client device of the user for immediate use;
download a local instance of the executable content to the client device of the user; and
install the local instance of the executable content on the client device of the user; and
when the local instance of the executable content is installed and ready to run on the client device:
select a swap-over point between the streaming instance and the local instance of the executable content;
at the swap-over point, create a save file that enables resumption of the executable content from the swap-over point;
download the save file to the client device of the user;
run the local instance of the executable content in a mode that starts the executable content using the save file to start the executable content at the swap-over point; and
transfer the user from the streaming instance of the executable content to the local instance of the executable content to continue their use of the executable content.

18. The client device of claim 17, wherein the streaming instance of the executable content is allocated a network priority greater than a network priority associated with downloading of the local instance of the executable content.

19. The client device of claim 18, wherein the network priority associated with at least downloading of the local instance of the executable content is adjusted to increase a download speed of the local instance of the executable content, subject to the streaming instance of the executable content meeting at least a threshold quality of service metric.

20. The client device of claim 17, wherein the instructions further cause the client device to:
save a save file for the streaming instance of the executable content, the save file being associated with an ID of the user;
quit or suspending the streaming instance of the executable content when the user quits the executable content; and
load the save file in a streaming instance of the executable content if the user accesses the executable content again before the user has been transferred to the local instance of the executable content.
